(19) United States
(12) Patent Application Publication
(10) Pub. No.: US 2005/0147004 A1
(43) Pub. Date: Jul. 7, 2005

(54) Audio data recording/reproduction system and audio data recording medium therefor

(75) Inventors: Michi Kumagai, Kodaira (JP); Akira Naito, Kodaira (JP)

Correspondence Address: Stanley P. Fisher;Reed Smith LLP, Suite 1400, 3110 Fairview Park Drive, Falls Church, VA, 22042-4503, US

(73) Assignee: Renesas Technology Corp.

(21) Appl. No.: 10/983,582

(22) Filed: Nov. 9, 2004

(30) Foreign Application Priority Data
Nov. 14, 2003 (JP) 2003-384556

(51) Int. Cl. G11B 5/09

(52) U.S. Cl. 369/47.19; 369/47.5

(57) ABSTRACT

An audio data recording/reproduction system which is simple in configuration, convenient and safe to use, and an audio data recording medium therefor is to be provided. A music data recording medium is configured in which power information correlated to the average sound pressure power of audio data matching music pieces (music programs) is recorded, appended to each of the music pieces (music programs). In the audio data recording/reproduction system, its encoding unit is provided with a power information generating section which, receiving digital audio data matching a music piece (music program), generates power information correlated to the average sound pressure power of the audio data, and records in the recording unit the generated power information made relevant to compressed data resulting from the compression of the digital audio data; and its decoding unit extracts the power information, restores the original digital audio data from the compressed audio data, and outputs the data adjusted on the basis of the power information, or outputs the restored digital audio data and the power information.

### CROSS REFERENCE TO RELATED APPLICATION

The present application claims priority from Japanese patent application No. 2003-384556 filed on Nov. 14, 2003, the content of which is hereby incorporated by reference into this application.

### BACKGROUND OF THE INVENTION

The present invention relates to an audio data recording/reproduction system and an audio data recording medium therefor, and more particularly to a technique which can be effectively applied to, for instance, an audio data recording/reproduction system for editing digital music data recorded on a plurality of compact discs digital audio (CD-DA) and audio data recording medium therefor.

Various recording/reproduction systems are proposed for use in reading out audio digital data from a CD-DA (CD ripping), compressing (encoding) them into AAC, MP3 or the like, and storing the compressed data on a recording medium, such as a hard disk or the like. In these already proposed systems, audio data are stored on the CD-DA with their recording level kept as it is. Regarding individual middleware items (decoder and encoders), there are MPEG1 Audio Layer3 (Protocol: ISO/IEC11172-3), MPEG2 Audio Layer3 (Protocol: ISO/IEC13818-3), MPEG2 Advanced Audio Coding (Protocol: ISO/IEC13818-7) and MPEG4 Advanced Audio Coding (Protocol: ISO/IEC14496-3) for instance.
Non-patent Reference 1: MPEG1 Audio Layer3 (Protocol: ISO/IEC11172-3)
Non-patent Reference 2: MPEG2 Audio Layer3 (Protocol: ISO/IEC13818-3)
Non-patent Reference 3: MPEG2 Advanced Audio Coding (Protocol: ISO/IEC13818-7)
Non-patent Reference 4: MPEG4 Advanced Audio Coding (Protocol: ISO/IEC14496-3)

### SUMMARY OF THE INVENTION

In view of the increasing trend of the storage capacities of hard disks and other media for storing audio data, the present inventors studied an audio data recording/reproduction system intended for selecting music pieces (music programs) of the user's choice out of more than one CD-DA and storing them as audio data. The recording level of CDs-DA differs from one CD-DA to another or, even on the same CD-DA, from piece (music program) to piece. Therefore, if a plurality of music pieces (music program) extracted from more than one CD-DA is stored on a recording medium, such as a hard disk, and are reproduced consecutively, the reproduced sound volume will fluctuate from piece (music program) to piece. Thus, on an actual listening occasion, the listener will have to manually adjust the amplitude to the optimal level every time the music piece (music program) changes. This fluctuation in reproduced volume is sometimes even dangerous. Especially where the listener is using a tightly closed item, such as a headphone, a combination of music pieces (music programs) which involves a sudden rise in reproduced volume would not only make the listener unpleasant but also give trouble to the auditory sense of other people around. Where a driver is playing a car audio while driving, a sudden rise in reproduced volume might divert his attention to volume adjustment and thereby affect his car driving action in response to a contingency.

FIG. 17 shows actual waveforms which will occur in a case wherein data from two CDs-DA are encoded and stored on a hard disk HD. Referring to this diagram, a rock music piece (music program) or the like is recorded on CD1 and a jazz music piece (music program) or the like is recorded on CD2. The sound power of piece A on CD1 is high while that of piece B on CD2 is low. Where piece B and piece A greatly differ in sound power are to be encoded and their data are to be stored on a hard disk HD for subsequent reproduction of the compressed data, if the volume is set to match piece B, the volume as it is will prove too high at the time of change from piece B to piece A, and require manual volume adjustment by the user, giving rise to the aforementioned risks.

An object of the present invention is to provide an audio data recording/reproduction system which is simple in configuration, convenient and safe to use, and an audio data recording medium therefor. This and other objects and novel features of the invention will become apparent from the description in this specification when taken in conjunction with accompanying drawings.

One of the typical aspects of the invention disclosed in the present application is briefly described below. Thus, an audio data recording medium is configured by recording audio data corresponding to a music piece (music program) and power information correlated to the average sound pressure power of the audio data, the power information being appended to the music piece (music program).

Another of the typical aspects of the invention disclosed in the present application is briefly described below. In an audio data recording/reproduction system, its encoding unit is provided with a power information generating section which, receiving digital audio data matching a music piece (music program), generates power information correlated to the average sound pressure power of the audio data, and records in a recording unit the generated power information made relevant to compressed data resulting from the compression of the digital audio data; the decoding unit extracts the power information from a read-out signal from the recording unit, and restores the original digital audio data from the compressed audio data, and the output unit adjusts the level of analog audio data generated from the restored digital audio data on the basis of the power information and outputs the adjusted data, or outputs the restored digital audio data and the power information.

When sound data differing in sound pressure power are reproduced, sound data which can make it unnecessary to adjust the sound amplitude every time a set of sound data to be produced changes from one to another can be reproduced generated or held.

### BRIEF DESCRIPTION OF THE DRAWINGS

FIG. 1 is a block diagram of an audio data recording/production system, which is a preferred embodiment of the present invention.

FIG. 2 is a block diagram of an example of encoding unit for use in the audio data recording/reproduction system pertaining to the invention.

FIG. 3 shows the configuration of an example of stream data form with power information pertaining to the invention.

FIG. 4 shows the basic bit configuration of MP3 to which the invention is applied.

FIG. 5 is a block diagram of an example of decoding unit for use in the audio data recording/reproduction system pertaining to the invention.

FIG. 6 is a flow chart showing an example of spectrum averaging pertaining to the invention.

FIG. 7 is a flow chart showing another example of spectrum averaging pertaining to the invention.

FIG. 8 illustrates one example of method of writing power information into compressed data pertaining to the invention.

FIG. 9 illustrates one example of method of reading the power level in decoding compressed data pertaining to the invention.

FIG. 10 shows the frame bit configuration of compressed data pertaining to the invention.

FIG. 11 is a block diagram of an example of decoding unit of the audio data recording/reproduction system pertaining to the invention.

FIG. 12 is a block diagram of another example of decoding unit of the audio data recording/reproduction system pertaining to the invention.

FIG. 13 is a block diagram of another example of encoding unit of the audio data recording/reproduction system pertaining to the invention.

FIG. 14 is a block diagram of still another example of encoding unit of the audio data recording/reproduction system pertaining to the invention.

FIG. 15 shows the configuration of an example of audio data recording medium pertaining to the invention.

FIG. 16 is a waveform diagram illustrating the operation of the audio data recording/reproduction system pertaining to the invention.

FIG. 17 shows actual waveforms which will occur in a case wherein data from two CDs-DA are encoded and stored on a hard disk.

### DETAILED DESCRIPTION OF THE PREFERRED EMBODIMENTS

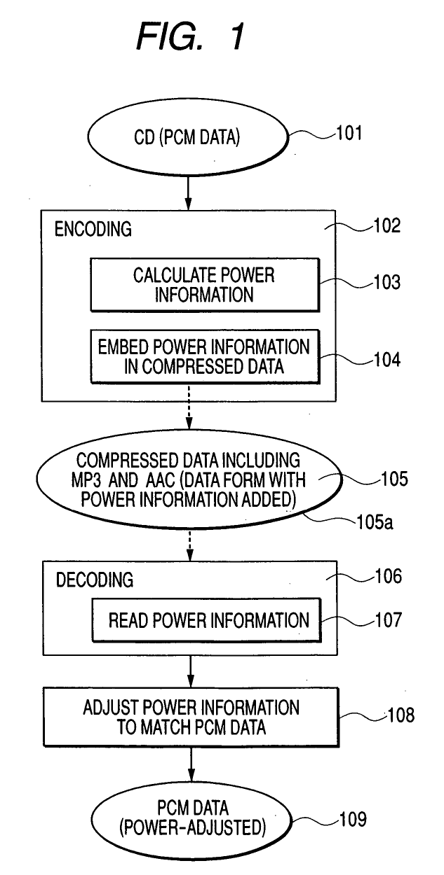

FIG. 1 is a block diagram of a recording/production system for audio data (sound data) pertaining to the present invention. The drawing represents the audio data recording/reproduction system in the form of a signal processing flow along the processing of signals for recording/reproducing audio data. Input audio data are, though not limited to, music data (:PCM data) 101 recorded on a CD-DA or the like. The system of this embodiment has in its encoding unit 102 a power information (sound pressure power) calculating section 103 and an embedding section 104 for embedding the power information generated in the power information calculating section 103 into compressed data formed in the encoding unit 102.

After the PCM data 101 are entered, the system of this embodiment adds the power information calculating section 103 and the embedding section 104 for embedding power information into compressed data to the encoding unit 102 as stated above to generate compressed data 105 with power information added. Such compressed data 105 with power information added, consisting of compressed data, such as MP3 or AAC for instance, to which the power information is added, are recording of a recording medium 105a, which may be a hard disk (HD), an optical disk or the like.

A decoding unit 106, receiving the compressed data 105 with power information added recorded on the recording medium 105a, takes out with a power information reading section 107 the power information added to the compressed data. An output section 108 adjusts the power of the PCM data in accordance with the power information. In other words, the decoding unit 106 of the system of this embodiment reads out the compressed data 105 with power information added, and extracts the power information out of the compressed data with the power information reading section 107. It also restores the compressed data into the previous form of PCM data.

In the output section 108, the volume of the PCM data is automatically adjusted in accordance with the power information acquired by the power information reading section 107. The adjustment of PCM data can as well be executed within the decoding unit 106 or outside the decoding unit (by an external decoding unit, such as an application). By the signal processing so far described, PCM data 109 are supposed to have been adjusted in volume (power).

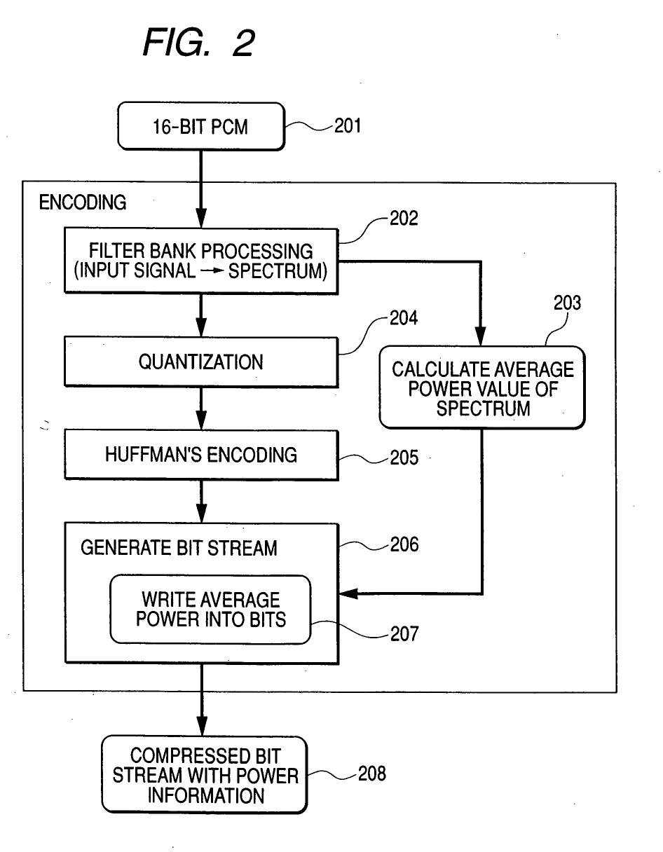

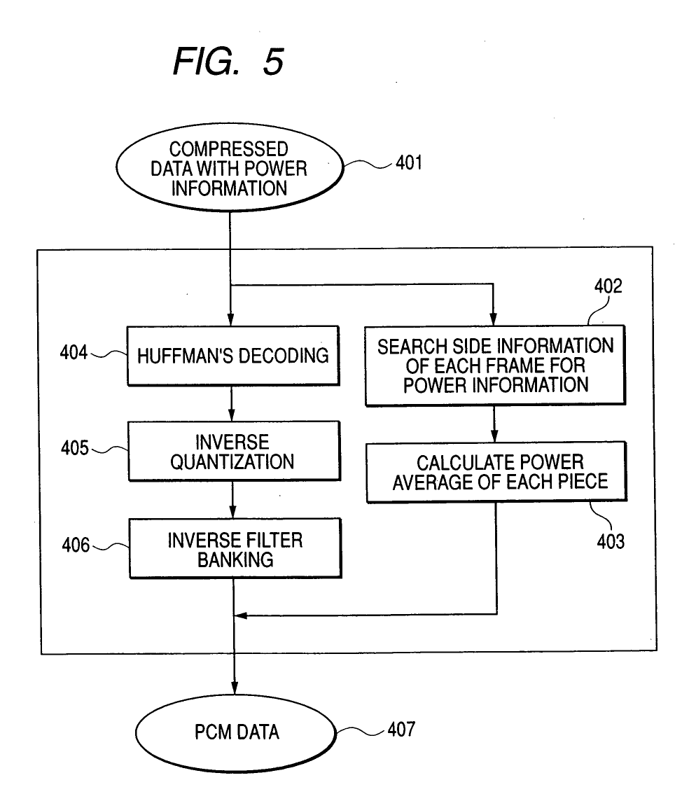

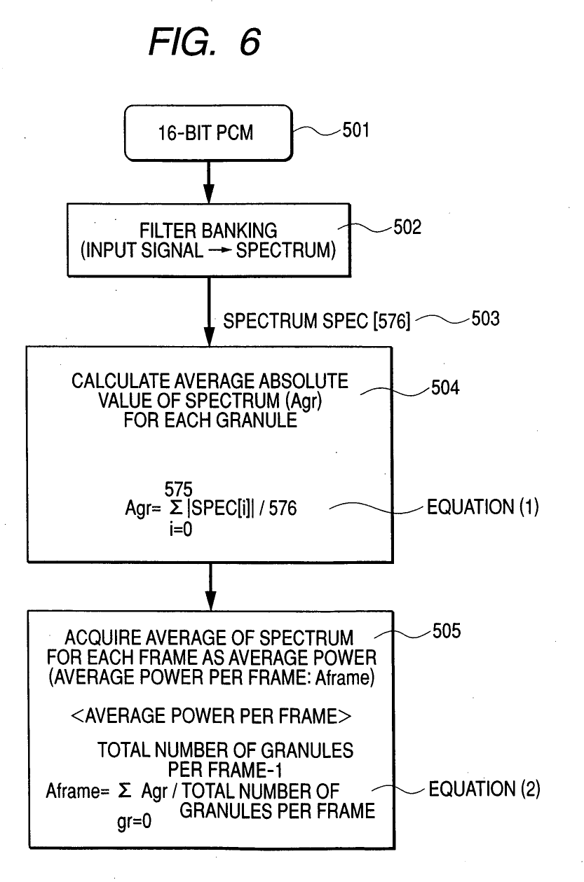

FIG. 2 is a block diagram of an example of encoding unit for use in the audio data recording/reproduction system pertaining to the invention. This drawing, too, represents the encoding unit in the form of a signal processing flow along the processing of signals. Thus, FIG. 2 shows a specific example of configuration of the encoding unit 102 in FIG. 1. Into the encoding unit of this embodiment, 16-bit PCM 201 is entered as input audio data. This input signal is converted into a spectrum by a filter bank processing section 202. This encoding is similar to conventional encoding, such as MP3 or AAC. In this embodiment, a calculating section 203 calculates the average power value of spectrum on the basis of the data converted into the spectrum. By calculating the average power value of spectrum on the basis of the data converted into the spectrum, the load of calculation is reduced, making it possible to require virtually no extra power consumption or processing time due to the calculation of the average power value. This processing to calculate the average power value of spectrum constitutes one of the characteristic features of the audio data recording/reproduction system pertaining to the invention. The actual method of calculating the power value will be described afterwards with reference to FIG. 5 and FIG. 6.

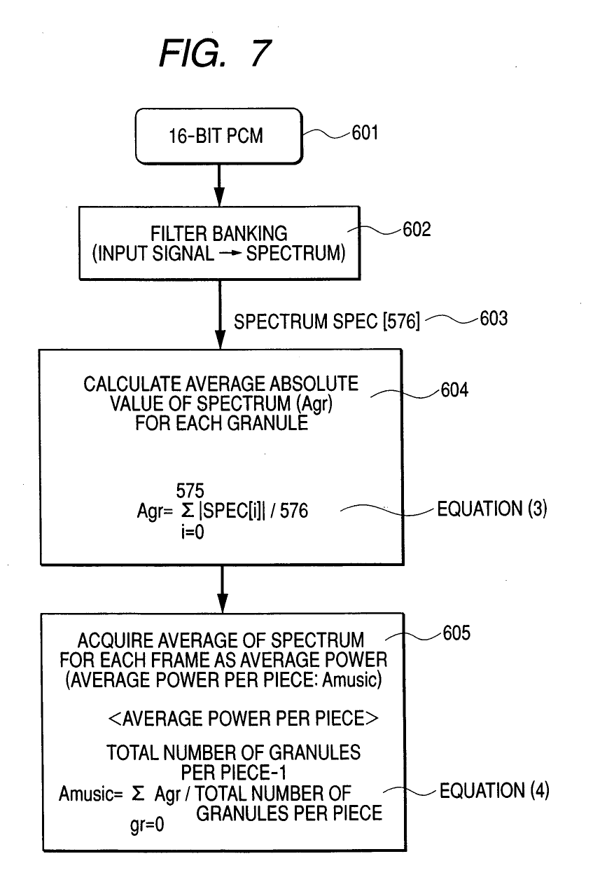

Apart from the calculation of the power value, quantization is processed by a quantizing section 204 as part of the encoding, and the quantized data undergo Huffman's encoding by a Huffman's encoding section 205. These quantization and Huffman's encoding are also similar to the conventional encoding. Then, there is provided a processing section 207 for inserting, while a bit stream generating section 206 is generating a bit stream (compressed data), the average power value of spectrum calculated by the calculating section 203. The method of this insertion of the average power value of spectrum into the bit stream will be described afterwards with reference to FIG. 7. While the generation of the bit stream in itself is similar to the conventional encoding, the presence of the processing section 207 to write the average power value into the compressed data constitutes one of the characteristic features of the present invention. A compressed bit stream 208 with power information added is generated in the procedure described above.

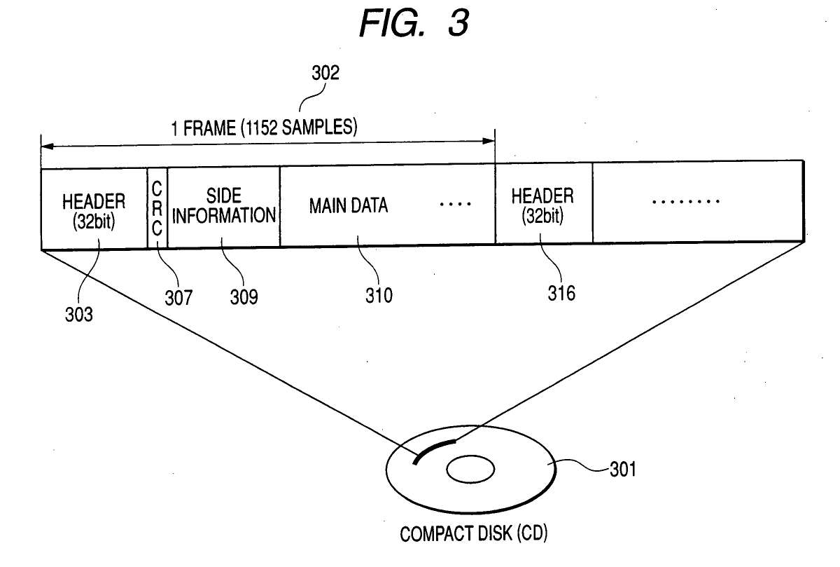

FIG. 3 shows the configuration of an example of stream data form with power information. This example is a case in which MP3 compressed data with power information added according to the invention is recorded on a compact disc (CD) 301. This corresponds to the recording medium 105a shown in FIG. 1. The data form of the stream constitutes part of the compact disc 301. In the data form of MP3, 1 frame 302 has a frame configuration of 1,152 samples each. The 1 frame 302 also consists of two granules, each granule consisting of 576 samples. The 1 frame 302 comprises a header 303, a CRC 307, side information 309 and main data 310.

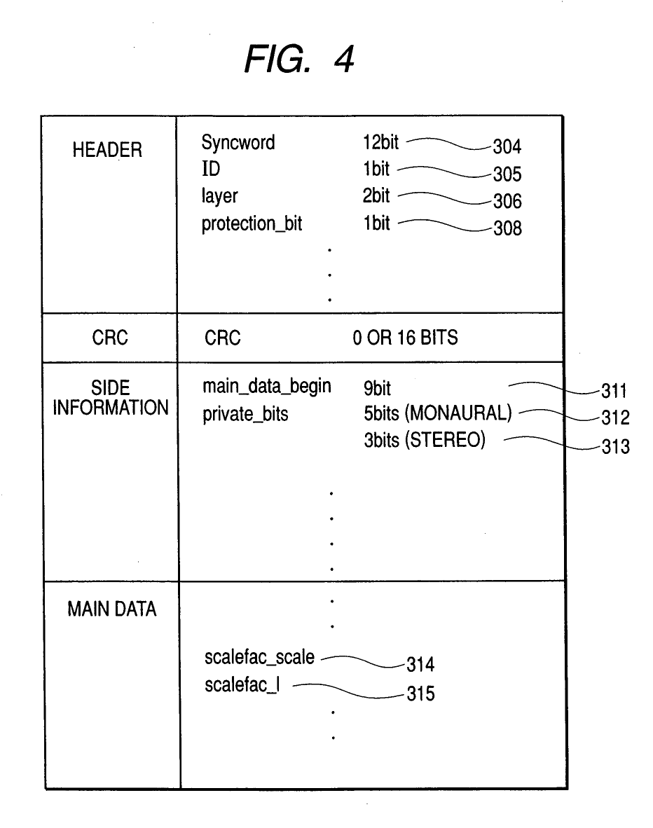

The basic configuration of each frame of MP3 begins, as shown in FIG. 4, with a header portion 303 which, totaling 32 bits, indicates the beginning of a frame and comprises a 12-bit Syncword 304, ID information 305, layer information 306, bit rate information and so forth. Next, there may be or may not be 16-bit error check information (CRC) 307. The presence or absence of the CRC 307 is determined by whether the value of the protection-bit 308 of the header is 0 or 1. Then follows side information (309) and so on. The side information (309) comprises 9-bit main_data_begin information 311 indicating the start of the main data 310 and private_bits 312 or 313, which are bits for private purposes. The private-bits 312 or 313 are prescribed to be 3 bits 313 for stereo and 5 bits 312 for monaural.

In this embodiment, the private_bits 312 or 313 in this side information 309 are used as bits into which the average power value is to be written. The bits into which the average power is to be written need not be the private_bits, but may be some other bits in the compressed data. Then come the main data 310, which are the actual audio compressed data. In the main data various data including scalefac_scale 314 and scalefac_1 315 are configured of bits. When the 1 frame is completed, the header 316 of 2 frame follows.

FIG. 5 is a block diagram of an example of decoding unit for use in the audio data recording/reproduction system pertaining to the invention. This drawing, too, represents the decoding unit in the form of a signal processing flow along the processing of signals. This decoding unit corresponds to the decoding unit 106 in FIG. 1. Compressed data 401 with power information added, which constitutes one of the characteristic features of the invention, read out of the recording medium and entered. The decoder searches with its searching section 402 the side information of each frame of the entered compressed data 401 for the power information, and reads out the power information that is found. The items of power information that have been found are averaged by a calculating section 403 to figure out the power average of each piece. In the decoding unit, the compressed data 401 are subjected to Huffman's decoding by a Huffman's decoding section 404, to inverse quantization by an inverse quantization section 405, and to inverse filter banking by an inverse filter banking section 406 to give PCM data 407. The processing by the sections from the Huffman's decoding section 404 to the inverse filter banking section 406 is similar to conventional decoding.

FIG. 6 is a flow chart showing an example of spectrum averaging (power calculation) pertaining to the invention. This spectrum averaging (power calculation) is an example of calculation by the power information calculating section 103 shown in FIG. 1. This example is one of MPEG1 Audio Layer3 (MP3). In MP3, processing usually takes place granule (576 samples) by granule. Input data (16-bit PCM (501)) are entered and subjected to filter banking 502 to convert the input signals into a spectrum. Here, a spectral information array consisting of 576 elements is represented by SPEC[576]. By calculation processing 504, the average absolute value of spectrum (Agr) is calculated for each granule as represented by Equation (1) below:

$$Agr = {\sum }_{i = 0}^{575} \vert SPEC [ i ] / 576 \qquad ( Equation 1 )$$

By calculation processing 505, Agr data for one frame are calculated, and the granule average per frame is calculated as the average power per frame (Aframe) by Equation (2) below:

$$Average power per frame ( Aframe ) = {\sum }_{gr = 0}^{Total number of gr per frame - 1} Agr \text{/} Total number of gr per frame \qquad ( Equation 2 )$$

FIG. 7 is a flow chart showing another example of spectrum averaging (power calculation) pertaining to the invention. This spectrum averaging (power calculation) is an example of calculation by the power information calculating section 103 in FIG. 1. This example is one of MPEG1 Audio Layer3 (MP3). While in the foregoing example of FIG. 6 the average power per frame is acquired as power information and written into compressed data frame by frame, in this example the power average is acquired for a whole music piece, and one unit of power information is acquired and written per piece. Input data (16-bit PCM (601)) are entered and subjected to filter banking 602 to convert the input signals into a spectrum. Here, a spectral information array consisting of 576 elements is represented by SPEC[576]. By calculation processing 604, the average absolute value of spectrum (Agr) is calculated for each granule as represented by Equation (3) below:

$$Agr = {\sum }_{i = 0}^{575} \vert SPEC [ i ] / 576 \qquad ( Equation 3 )$$

By calculation processing 605, Agr data for one frame are calculated, and the spectral average for one piece is acquired from those data the average power per piece. The granule average is calculated as the average power per piece (Amusic) by Equation (4) below:

$$Average power per piece ( Amusic ) = {\sum }_{gr = 0}^{Total number of gr per piece - 1} Agr \text{/} Total number of gr per piece \qquad ( Equation 4 )$$

While the example shown in FIG. 6 is one in which power information is added to each frame, in this example power information may be written into either the side information of the starting frame of the piece or the side information of the final frame or, with the possibility of reproduction from midway taken into consideration, power information may be written into the side information of every frame. Where such a data form is used, the power average of the whole piece can be acquired by reading the power information of the starting frame, the final frame or any one frame on the way. For this reason, unlike where the data form of FIG. 6 is used, there is no need to search all the frames of the decoded piece to calculate the power average. The calculation of the average power information of one piece as in this example can also be applied a data form having only one header portion at the beginning of a piece as in the ADIF form of MPEG Advanced Audio Coding, if the power information is to be written into the header portion.

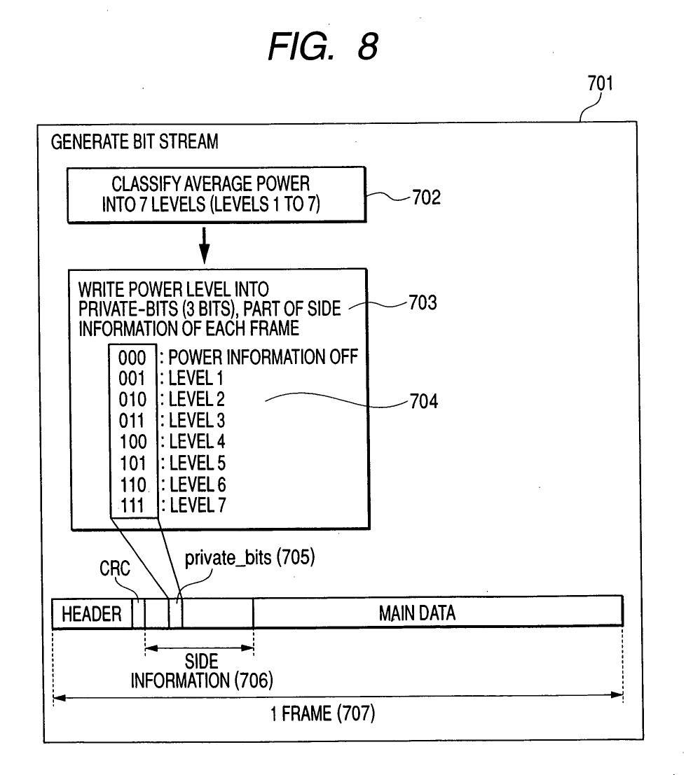

FIG. 8 illustrates one example of method of writing power information into compressed data pertaining to the invention. This corresponds to the method of writing by the embedding section 104 in FIG. 1. From the data acquired for the average power per frame calculated as shown in FIG. 6 above (Aframe) (Equation (2)), power information is classified into seven power levels by classification processing 702. The power level information obtained by this classification is written into private_bits 705 constituting part of side information 706 of the matching frame 707. This example is one in which three bits of the private_bits are used.

One example 704 of power level information is shown below.
000: Power information off (none)
001: Power level 1
010: Power level 2
011: Power level 3
100: Power level 4
101: Power level 5
110: Power level 6
111: Power level 7

In the seven-level power level classification above, the group of CDs whose power level is the lowest is supposed to be level 1, and the group of CDs whose power level is the highest is supposed to be level 7. For the purpose of this classification, the average power per music piece (music program) is figured out for a plurality of CDs containing all genres of music, and the CDs are statistically classified into seven groups. It is necessary here to classify them into seven levels of the average power as aurally sensed. In this way, power levels from level 1 to level 7 above are arranged linearly as aurally sensed. It is possible to set more than seven power information levels where a greater number of bits can be used in the recording section for recording the power information. Also, the position into which the power level information is to be written need not be where the level information is the private_bits.

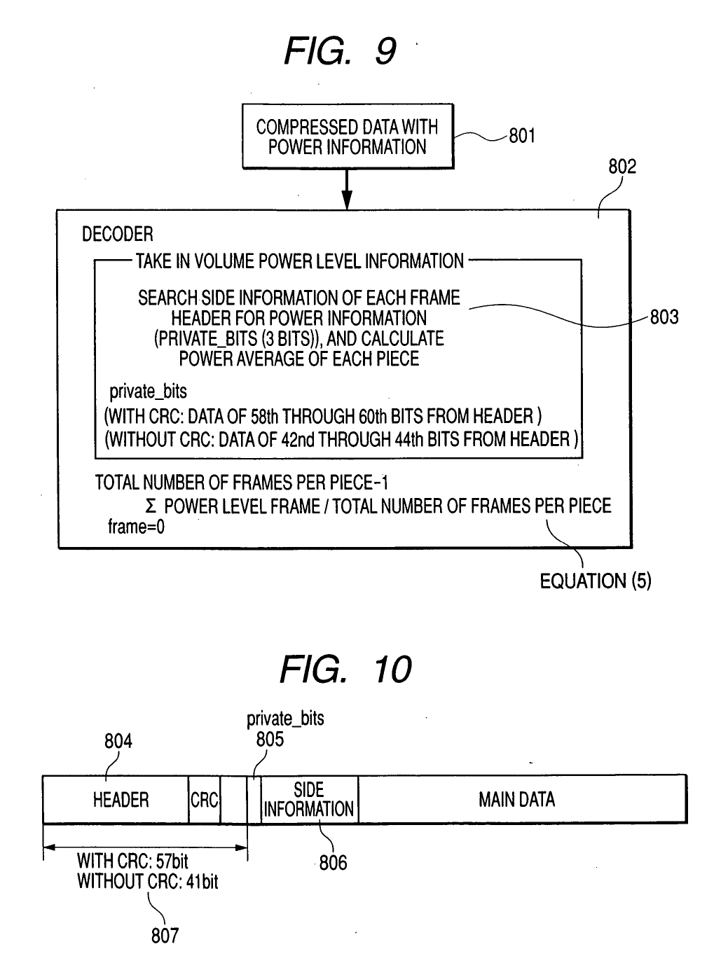

FIG. 9 illustrates one example of method of reading the power level in decoding compressed data pertaining to the invention. This corresponds to the calculation processing 403 in FIG. 5 above. FIG. 9 shows a case in which the power level of each frame is entered in the private_bits of the side information of each frame in the compressed data of MP3. A decoder unit 802 in which compressed data 801 with power information added are entered subjects to search processing 803 the power level embedded in the private-bits of each frame for a whole piece, and calculates the power average of each piece by Equation (5) below.

$$Power Information of each piece = {\sum }_{frame = 0}^{Total number of frames per piece - 1} Power level frame \text{/} Total number of frames per piece \qquad ( Equation 5 )$$

As shown in the frame bit configuration diagram of FIG. 10, private-bits 805 begin with the 58th bit from the start of the frame when with CRC or with the 42nd bit when without CRC as shown in 807. For this reason, they can be located by counting the number of bits from the start of the frame and reading out three bits beginning with the pertinent bit. It is possible, though not required, to calculate the power average by searing only the power information of the header before decoding music data.

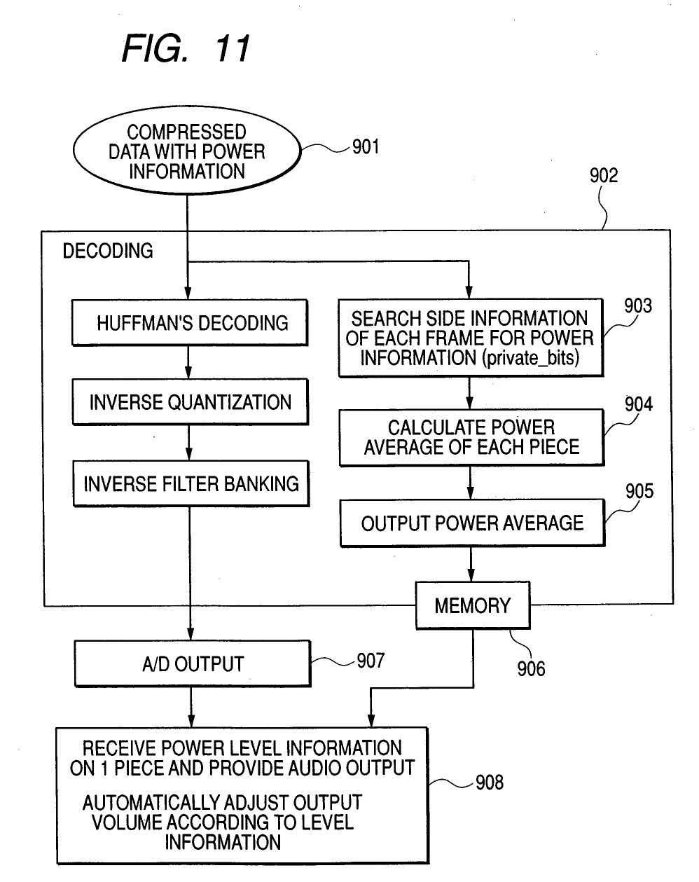

FIG. 11 is a block diagram of an example of decoding unit of the audio data recording/reproduction system pertaining to the invention. This drawing, too, represents the decoding unit in the form of a signal processing flow along the processing of signals. This embodiment is intended for a system in which power information is read within the decoding unit and power is adjusted outside the decoding unit. Compressed data 901 with power information added are entered into a decoding unit 902. Power information is acquired and stored by a search unit 903, a calculating unit 904, an output unit 905 and a memory 906. The sequence of operations to generate PCM data by Huffman's decoding, inverse quantization and inverse filter banking is the same as what is shown in FIG. 5 above. The difference from what is shown in FIG. 5 above consists in that, after the power average per piece is calculated by the calculating unit 904, the output data of the power average are temporarily caused to be some kind of memory 906 via the output unit 905.

On the other hand, the PCM data obtained as a result of decoding are converted into analog signals by a digital-to-analog D/A converting unit 907. When they are to be issued outside by means of a loudspeaker or headphones, the output volume (sound amplitude) is automatically by an output volume control unit 908 by using the power average information held in the memory 906. The volumes of different pieces are thereby averaged, and the problem of a sudden increase (or decrease) in volume depending on the piece is eliminated. Thus, where the seven-level information described above is recorded, pieces of levels 3, 2 and 1 below the intermediate level 4 are raised in volume toward the target of level 4, while pieces of levels 5, 6 and 7 above that are attenuated toward the target of level 4. Any piece determined to be level 4 is reproduced as it is.

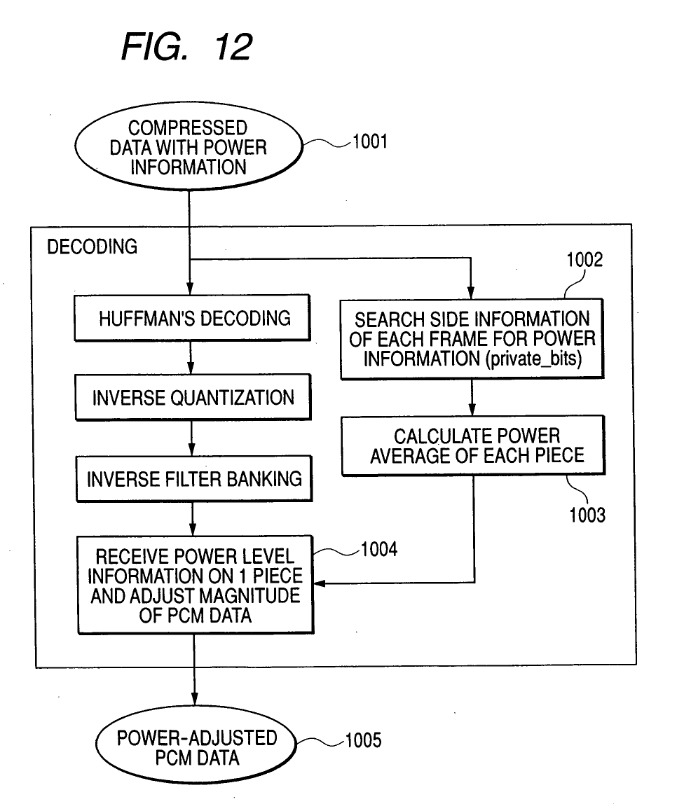

FIG. 12 is a block diagram of another example of decoding unit of the audio data recording/reproduction system pertaining to the invention. This drawing, too, represents the decoding unit in the form of a signal processing flow along the processing of signals. While the power level of each music piece (music program) is acquired within the decoding unit and the volume (sound amplitude) is adjusted by using this power level outside the decoding unit in the examples shown in FIG. 1 and FIG. 11 above, power adjustment for the volume (PCM data here) is performed within the decoding unit in the embodiment of FIG. 12. In this case, no volume adjustment with an external application, such as an MP3 player is needed.

After compressed data 1001 with power information is entered into a decoding unit, the sequence until they go through Huffman's decoding, inverse quantization and inverse filter banking to generate PCM data is the same as its counterpart in FIG. 5 above. A search section 1002 extracts the power information, and the power average of each piece is calculated by a calculating section 1003. After the PCM data are generated, information on the power average of each piece from the calculating section 1003 is received, the magnitude of the PCM data is adjusted by an adjusting section 1004 to the power average within the decoding unit as stated above. PCM data 1005 having gone through power adjustment are thereby generated.

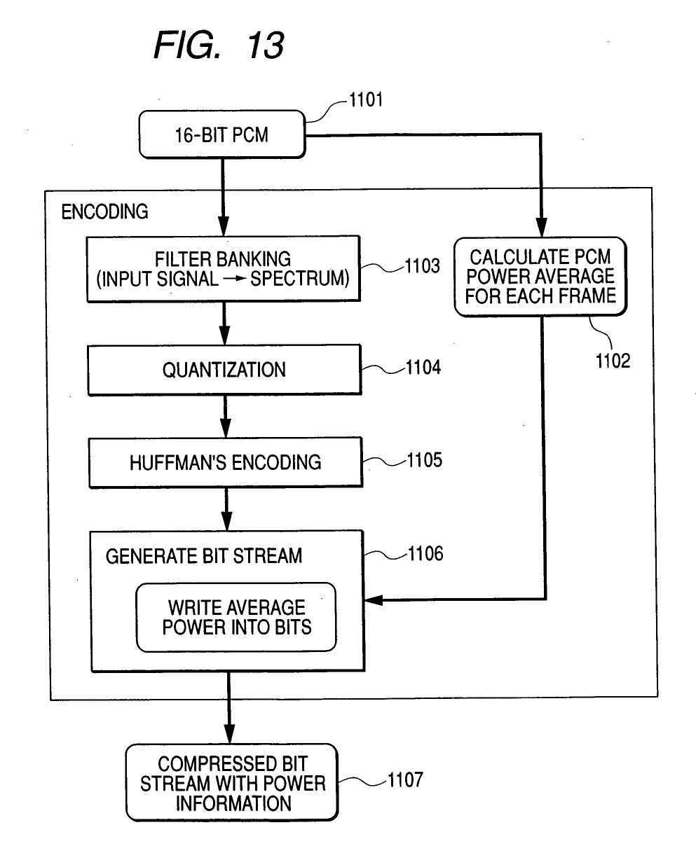

FIG. 13 is a block diagram of another example of encoding unit of the audio data recording/reproduction system pertaining to the invention. In the example shown in FIG. 2 above, after filter banking, power information is acquired after converting the PCM data into spectral data. Unlike this, in the example shown in FIG. 13, when PCM data 1101 are entered into the encoding unit, a calculating section 1102 acquires the power average of the PCM data before filter banking by a filter banking section 1103. As the PCM data 1101 are entered, the calculating section 1102 calculates the PCM power average of each frame.

After that, encoding is performed by the filter banking section 1103, a quantizing section 1104 and a Huffman's encoding section 1105 to accomplish data compression, and a bit stream generating section 1106 writes the average power (the average power for each frame of the PCM data in this example) into prescribed bits. As a result, a compressed bit stream 1107 with power information added can be supplied. That is to say, it is stored in a recording medium not shown.

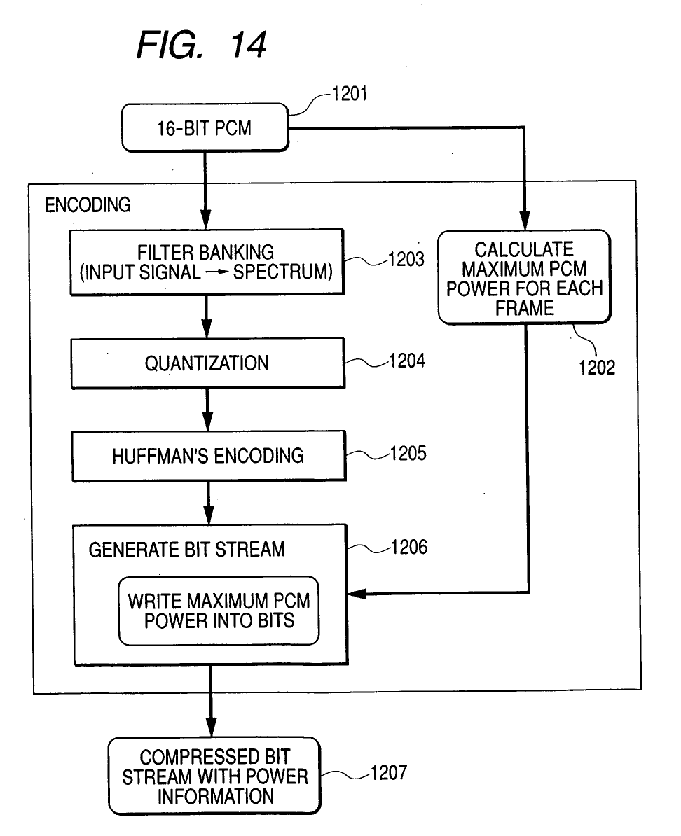

FIG. 14 is a block diagram of still another example of encoding unit of the audio data recording/reproduction system pertaining to the invention. In this example, a calculating section 1202 calculates the maximum power value of input PCM 1201, and acquires the maximum value as power information. This power information is used for the adjustment of output sound amplitude (volume adjustment). The power information here may as well be the minimum value, the power of PCM or the power of the spectrum after filter banking. After the acquisition of the power information, a bit stream generating section 1206 writes the information into bits.

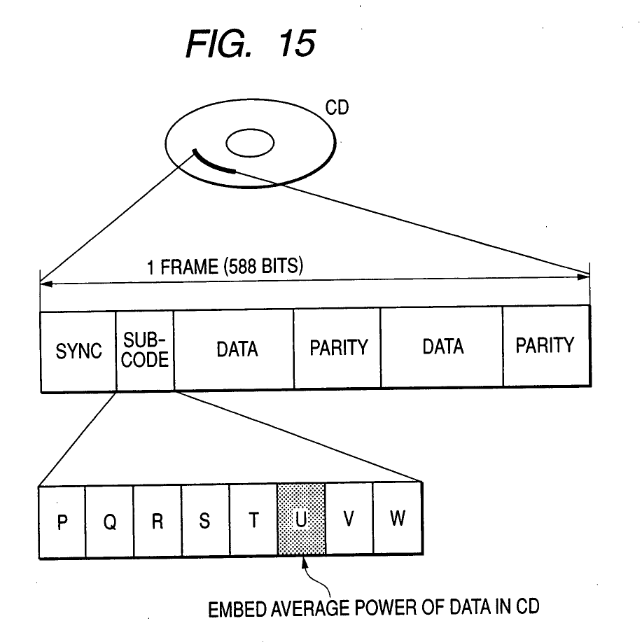

FIG. 15 shows the configuration of an example of audio data recording medium pertaining to the invention. This example of application of the invention to a compact disc digital audio (CD-DA). The protocol-prescribed format of a CD-DA consists of 588 bits including data of 24 bytes (=192 bits) per frame, information for error correction and so forth. These 588 bits include an eight-bit subcode. The subcode is composed of a P bit, Q bit, R bit, S bit, T bit, U bit, V bit and W bit. One sector (one block) consists of 98 frames.

Bits of the same denomination from the 98 frames constituting a block are treated as a sub-channel, of which there are eight, such as a P channel of 98 P bits or a Q channel of 98 Q bits. According to the protocol, some of the channels are already used for CDs-DA and karaoke CDs (P channel, Q channel, etc.). As the U channel is an unoccupied channel at present, power information can be embedded into the U channel. For the power information, the average power, the maximum power or the minimum power of each piece can be written in accordance with the method of calculated described above.

When such a CD-DA is played back on a CD player, the output sound volume is automatically adjusted according to the power information. Especially for a car audio system using an automatic CD changer permitting the mounting of a plurality of CDs-DA, when a plurality of CDs are to be consecutively played back, volume adjustment at every time of CD change can be made unnecessary. In the above-described audio data recording/reproduction system according to the invention under the present application, power information recorded on a CD-DA can be extracted as it is, matched with compressed data and recorded on a recording medium, such as an HD. In this case, when PCM data with power information added are entered into the audio data recording/reproduction system according to the invention under the present application, the aforementioned calculation processing is not performed by the power information calculating section 103 of the encoding unit 102 or the like, but it is only necessary to extract the power information from the U channel of the entered PCM data.

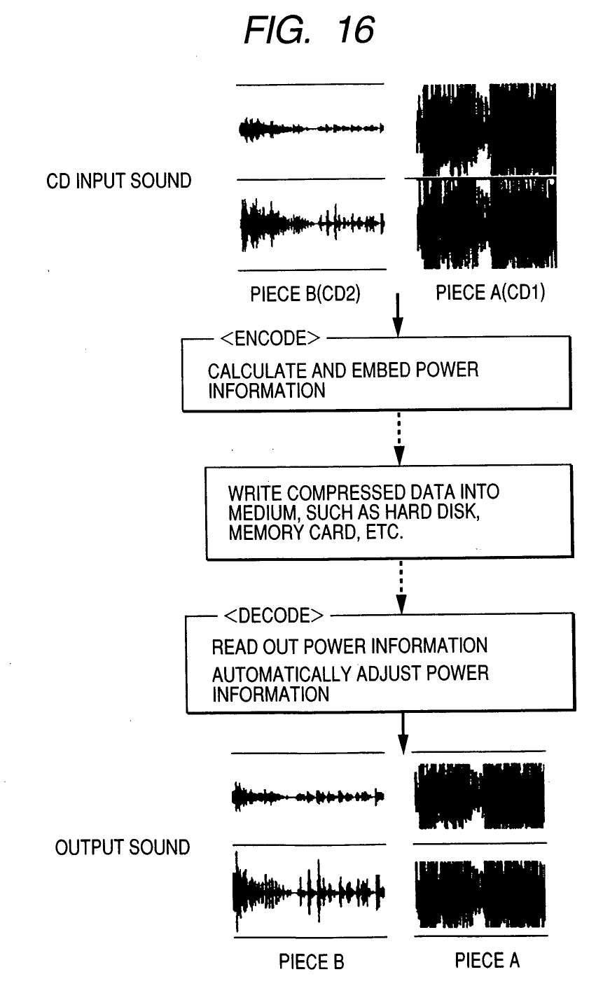

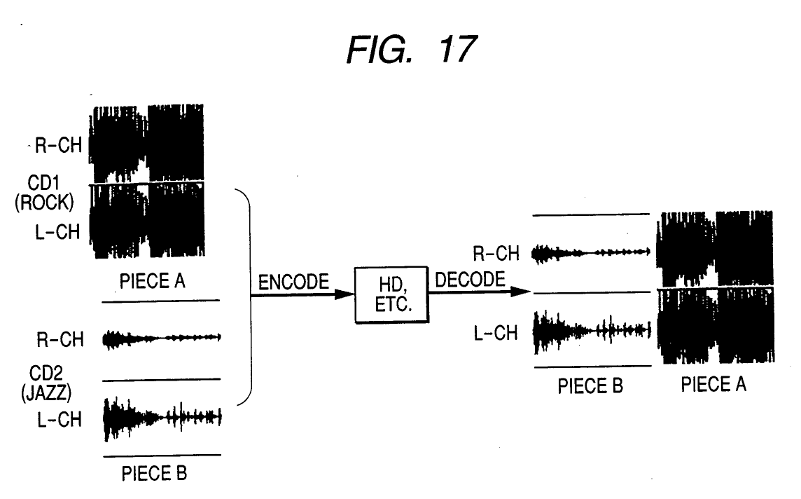

FIG. 16 is a waveform diagram illustrating the operation of the audio data recording/reproduction system pertaining to the invention. This is a diagram of actual waveforms which are generated when data from two CDs-DA are encoded, stored on a hard disk or the like and reproduced. Regarding the CD input signals whose waveforms are shown, a rock music piece (music program) or the like (piece A) is recorded on CD1 and a jazz music piece (music program) or the like (piece B) is recorded on CD2 as in the earlier described with reference to FIG. 17. In this case, the sound power of piece A on CD1 is high while that of piece B on CD2 is low. In the process of encoding piece B and piece A which greatly differ in sound power, the power information is calculated, embedded into the respective bit streams when they are generated, and the data are recorded on a recording medium, such as a hard disk or a memory card. When reading out data from this recording medium and reproducing the read-out compressed data by decoding, the power information, and on that basis the respective output volumes of piece B and piece A are automatically adjusted. In other words, the volume of piece B is increased while that of piece A is decreased. As a result, the trouble of deliberately adjusting the volume when changing from piece B to piece A is eliminated.

According to the invention under the present application, as described with reference to its embodiment described above, when audio data read out of a CD-DA are compressed (encoded) into an AAC or MP3 form, data indicating the recording level of (power information on) the CD-DA is generated, and the power information is embedded into the compressed data. Thus, the power information is embedded in these compressed data. When the audio data stored in a compressed form are to be expanded for reproduction (decoded), the reproduced volume is automatically adjusted in accordance with the data on the recording level embedded in the compressed data. A number of methods or mechanisms can be proposed, as described above, for the calculation of the power information, its embedding into the compressed data, determination of the reproduced volume, decoding and automatic adjustment. The power information (recording level information) added at the time of compression (encoding) can be extracted at the time of reproduction (decoding) as control data for the reproduced volume. When compressed data are to be reproduced by a product such as an MP3 player or a navigation system, fluctuations in the sound volumes of music pieces (music programs) mainly from CD to CD can be automatically adjusted by reading out power information (recording level information) according to the invention. The user can be thereby saved the trouble of adjusting the volume for himself according to the genre of the piece or some other factor.

The embodiment of the invention so far described can eliminate the need for volume adjustment when the music piece (music program) is changed in consecutive playback of a plurality of music pieces (music programs). Only by extracting at the time of CD ripping the power information stored in a CD-DA and adding it to the compressed data, the volume need not be adjusted at every time of changing from one edited music piece (music program) to another. By recording calculated power information on a recording medium together with music piece data or compressed data, the need to adjust the volume every time of changing from one edited music piece (music program) to another can be eliminated. Possible disturbance of the auditory sense at the time of using headphones can be prevented, or a car audio system for pleasant and safe driving can be realized.

Although the invention by the present inventors has been described above in specific terms with reference to the preferred embodiment thereof, the invention is not confined to this embodiment, but can be modified in various ways without deviating from its true spirit and scope. For instance, the calculation power information can be accomplished in various ways. The means of calculating power information can be, besides dedicated hardware for signal processing, either wholly or partly software executed by a microprocessor or a microcomputer consisting of a microprocessor and a coprocessor dedicated to specific types of arithmetic operation. This invention will find extensive use in navigation systems mounted with such audio functions as AAC/MP3, AAC/MP3 players, sound encoders and decoder-mounted equipment in general. The applicable audio data recording media include CDs-DA, CVDs, CD-ROMs, hard disks, MD disks, memory chips and memory cards.

1. An audio data recording medium which records audio data, and power information correlated to a sound pressure power of the audio data.

2. The audio data recording medium according to claim 1,
wherein the audio data are formed by compressing digital audio data, and
wherein the power information derives from replacement of average sound pressure power calculated from the digital audio data with a predetermined plurality of power levels.

3. The audio data recording medium according to claim 1,
wherein the audio data are digital audio data recorded on a compact disc, and
wherein the power information derives from replacement of average sound pressure power calculated from the digital audio data recorded on the compact disc with a predetermined plurality of power levels, the power information being recorded correspondingly to each music piece (music program) on the compact disc.

4. The audio data recording medium according to claim 3,
wherein the power levels are set in a plurality to vary linearly as aurally sensed between the supposed lowest and highest levels to be reached by the music pieces (music programs).

5. The audio data recording medium according to claim 2,
the recording medium having a plurality of frames each of which comprises a header portion, a CRC portion, a side information portion and a main data portion,
wherein the audio data are recorded in the main data portion in each of the frames, and
wherein the power information is recorded in a private bit area contained in the side information in each of the frames.

6. The audio data recording medium according to claim 1,
wherein the audio data match music pieces (music programs), and
wherein the sound pressure power is obtained by averaging sound amplitudes of the audio data.

7. The audio data recording medium according to claim 1,
the audio data recording medium having a plurality of frames each of which comprises a header portion and a main data portion, and
wherein the sound pressure power is recorded to frame by frame of power information correlated to average sound pressure power in each of the frames.

8. The audio data recording medium according to claim 1,
wherein the sound pressure power is power information correlated to average sound pressure power in each of music pieces (music programs).

9. An audio data recording/reproduction system, comprising:
an encoding unit;
a recording unit;
a decoding unit; and
an output unit,
wherein the encoding unit is provided with a power information generating section which, upon receiving digital audio data matching a music piece (music program), generates power information correlated to average sound pressure power of the audio data, and records in the recording unit the generated power information made relevant to compressed data resulting from compression of the digital audio data,
wherein the decoding unit, upon receiving a read-out signal from the recording unit, extracts the power information and restores original digital audio data from the compressed audio data, and
wherein the output unit adjusts level of analog audio data generated from the restored digital audio data on the basis of the power information and outputs the adjusted data, or outputs the restored digital audio data and the power information.

10. The audio data recording/reproduction system according to claim 9,
wherein the audio data are digital audio data recorded on a compact disc, and
wherein the power information derives from replacement of average sound pressure power calculated from the digital audio data recorded on the compact disc with a predetermined plurality of power levels.

11. The audio data recording/reproduction system according to claim 10,
wherein the power levels are set in a plurality to vary linearly as aurally sensed between the supposed lowest and highest levels to be reached by music pieces (music programs).

12. The audio data recording/reproduction system according to claim 11,
wherein the recording unit has a plurality of frames each of which comprises a header portion, a CRC portion, a side information portion and a main data portion,
wherein the audio data are recorded in the main data portion in each of the frames, and
wherein the power information is recorded in a private bit area contained in the side information in each of the frames.

13. The audio data recording/reproduction system according to claim 12,
wherein the audio data recording/reproduction system is contained in automobile-mounted audio equipment.

14. The audio data recording/reproduction system according to claim 12,
wherein the audio data recording/reproduction system is contained in portable audio equipment whose audio output means is headphones.
